(19) United States
(12) Patent Application Publication
(10) Pub. No.: US 2018/0365724 A1
(43) Pub. Date: Dec. 20, 2018

(54) COMPREHENSIVE BUSINESS AND MARKETING PLATFORM AND SYSTEM

(71) Applicant: Hakim Kabir, Alta Loma, CA (US)

(72) Inventor: Hakim Kabir, Alta Loma, CA (US)

(21) Appl. No.: 16/111,625

(22) Filed: Aug. 24, 2018

(51) Int. Cl. G06Q 30/02

(52) U.S. Cl. CPC G06Q 30/0214; G06Q 30/0241; G06Q 30/0282; G06Q 30/0201

(57) ABSTRACT

The embodiments herein provide a global business platform/system to connect consumers to businesses/merchants and vice versa through two way communication link. The consumers are allowed to refer friends, family members, and other consumers including themselves to the merchants through this platform and to receive a reward/referral fee for the same in the process. The merchants are configured to market their name, products and/or services to the consumers. Both the consumers and the merchants are allowed to rank their experience during and after the transaction process. The platform acts as a data-collection source for consumer and business behavior. The data collected is used for further analysis. The merchants are enabled to utilize their existing client lists to market, get referrals, cross-sell and record all transactions on a ledger.

### BACKGROUND

### Technical field

The embodiments herein are generally related to the field of business and marketing methods. The embodiments herein are particularly related to a system and method for providing a global business platform. The embodiments herein are more particularly related to a system and method for providing a global business platform for establishing two way communication/links to connect consumers to businesses and vice versa. The embodiments herein are especially related to a system and method for integrating advertisement spends to sales in order to change the market pattern from Business-To-Consumer to Consumer-To-Business.

### Description of the Related Art

With the advent of technology, businesses are increasingly making use of Internet for selling and marketing products and services. Companies try to explore newer ways and marketing strategies for reaching out to potential new consumers and members. With the continuous growth of marketplace for modern business, companies need to maintain a competitive edge. Thus, companies are always on a look out for various ways of expanding their consumer base.

The various methods used by companies for expanding consumer base include providing products at discounted prices, offering discount coupons for consecutive purchase made by the consumer, adding reward points to the consumer account for referring a particular product to other consumers and the like.

However, at present, there are several online shopping and consumer referral services that facilitate merchant-consumer interaction but do not provide a platform for connecting consumers to businesses and vice versa. Further, retaining a consumer on such a platform i.e. making sure that consumers continue to use a given platform for a longer duration of time has also become difficult with the ever increasing competition and options. Most of the time, the consumers prefer to switch to different platforms due to lack of continuous financial benefit.

Hence, there is a need for providing a global business platform to provide a two way link/communication to connect the consumers to businesses and vice versa. There is also a need for a system and method for providing a global business platform that enables consumers to refer friends, family members, and other consumers including themselves to businesses. Further, there is a need for a system and method that enables consumers to receive a reward/referral fee for referring other consumers to the platform. Still further, there is a need for a platform that helps in increasing a consumer retention period by providing continuous financial benefits to the consumers while transacting through the platform. Yet further, there is a need for a system and method for integrating advertisement spends to sales in order to change the market pattern from Business-To-Consumer to Consumer-To-Business.

The above mentioned shortcomings, disadvantages and problems are addressed herein and which will be understood by reading and studying the following specification.

### OBJECTS OF THE EMBODIMENTS HEREIN

The primary object of the embodiments herein is to provide a global business platform to provide a two way link/communication to connect the consumers to businesses and businesses to the consumers.

Another object of the embodiments herein is to provide a system and method for providing a global business platform that enables the consumers to refer friends, family members and other consumers including themselves to businesses.

Yet another object of the embodiments herein is to provide a system and method that enables the consumers to receive a reward/referral fee for referring other consumers to the platform.

Yet another object of the embodiments herein is to provide a system and method that allows the businesses associated with the platform to market their name, products and/or services to the consumers.

Yet another object of the embodiments herein is to provide a global business platform that enables both the consumers/customers and businesses/merchants/marketing associate/business associates to rate each other's (ones) experience after the transaction process.

Yet another object of the embodiments herein is to provide a global business platform that acts as a data collection source for the consumer and business behavior and further analyses the collected data to provide meaningful insights.

Yet another object of the embodiments herein is to provide a global business platform that allows the businesses to utilize a list of the existing clients to market, get/receive referrals, cross-sell and record all the transactions on a ledger.

Yet another object of the embodiments herein is to provide a business platform that helps in increasing the consumer retention period by providing continuous financial benefits to the consumers while transacting through the platform.

Yet another object of the embodiments herein is to provide a system and method for integrating advertisement spends to sales in order to change the market pattern from Business-To-Consumer to Consumer-To-Business.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The various embodiments herein disclose a system for providing a comprehensive business platform. The platform comprises a server communicatively coupled with one or more computing devices of the consumers and the merchants involved in a business activity, and wherein the one or more computing devices comprise a smartphone, a computer, a tablet and a personal digital assistant (PDA). The server comprises an on-boarding module configured for registering a plurality of consumers and merchants involved/engaged in a business activity with the system. The plurality of consumers and merchants register with the system through the respective computing devices by providing one or more personal details. The server also comprises a marketing module configured for enabling the merchants registered with the platform to advertise and sell their brand names, products and services to the consumers. The server further comprises a transaction processing module configured for processing the transactions related to the products and services purchased by the consumers using the platform. The transaction details of all the transactions performed through the platform are stored in the database. The server still further comprises a referral tracking module configured for keeping a track of the consumers who refer other consumers to the platform. The server still further comprises a reward allocation module configured for rewarding a referral fee to the consumers for referring themselves other consumers/leads to the platform.

According to an embodiment herein, the server further comprises a verification module configured for verifying the personal details of each consumer and merchant before on-boarding/registering to the marketing and business platform.

According to an embodiment herein, the server further comprises an analysis module configured for analyzing the data stored in the database to determine a consumer behavior and a merchant behavior, and wherein the analysis results are shared with the consumers and the merchants in the form of one or more reports.

According to an embodiment herein, the server further comprises a rating module configured for enabling the consumers and the merchants to rate each other at the end of each transaction. The consumers are prompted to rate/evaluate the merchant based on the services provided and the merchants are prompted/enabled to rate the consumer based on the quality of the referral.

According to an embodiment herein, the consumer referring other consumers to the platform are termed as marketing associates. The reward allocation module is further configured for allocating a reward/referral fee to the consumers when the lead results in a sale. The reward comprises loyalty points, discount coupons, cash back offer, gift voucher/card and product and service rebate.

According to an embodiment herein, the server further comprises a ledger module configured for recording all the leads and sales resulting from that lead, and wherein merchants are enabled to download consolidated transactional information from the ledger module.

According to an embodiment herein, the platform is further configured for providing a downloadable mobile application and web application respectively for the consumers and the merchants to access the platform. The consumers and merchants are registered with the platform through the mobile application and web application after downloading and installing the application and after providing one or more personal details. The consumer is enabled to create a profile during registration with the system. The merchant need to pay a licensing fee during registration.

According to an embodiment herein, the on-boarding/log-in module is further configured for sending a legal agreement to the merchant for e-signing before completing the registration process.

According to an embodiment herein, the platform enables the consumers to make payments using the credit cards, debit cards, prepaid cards, cash on delivery, internet banking and link payments.

According to an embodiment herein, the one or more personal details provided by the merchant during registration with the system comprise a business name, description, address location, phone number, email ID, debit/credit card details, Venmo/Paypal account details, hours of operation, business logo and social media links.

According to an embodiment herein, the one or more personal details provided by the consumer during registration with the system comprise phone number, email ID and debit/credit card details.

According to an embodiment herein, the consumer needs to provide one or more personal details of the consumer he/she is referring for the merchant to contact this newly created lead.

According to an embodiment herein, a method is provided for creating a global business and marketing platform that enables consumers to refer friends, family members and other consumers including themselves to businesses. The method comprises providing a downloadable mobile and web application for the plurality of consumers and merchants respectively to install on the computing devices to onboard the platform. The plurality of consumers and merchants are registered with the platform using one or more personal details provided by individual consumer and merchant through the respective user devices/computing devices. The merchants are enabled to advertise and sell their brand names, products and services to the consumers through the platform using an interactive/transaction module/application. The consumers are enabled to buy the one or more products or services marketed by the merchants through the platform using the interactive/transaction module/application. The transactions related to the products and services purchased by the consumers are processed and analyzed through an analysis module using the platform. The transaction details of all the transactions performed through the platform are stored in a database. The plurality of consumers and the plurality of merchants are prompted to evaluate/rank/rate each other through a ranking module at the end of each transaction. The consumers are advised/enabled to refer themselves or other consumers to the platform through a referral module. The consumers are awarded/rewarded with a referral fees/incentives/vouchers/gift coupons for referring consumer/lead to the platform through an awarding/rewarding module when the lead results into a sale.

According to an embodiment herein, the method further comprises verifying personal details of each consumer and merchant before on-boarding to the platform through a verification module.

According to an embodiment herein, the method further comprises recording all leads and sales resulting from that lead using a ledger module. The merchants are enabled to download transactional information from the ledger module.

According to an embodiment herein, the method further comprises enabling the consumers to make payments using credit cards, debit cards, prepaid cards, cash on delivery, interne banking and link payments.

According to an embodiment herein, the method further comprises keeping a track of the consumers who refer other consumers to the platform using a referral tracking module.

According to an embodiment herein, the method further comprises analyzing the data stored in the database to determine a consumer behavior and a merchant behavior. The analysis results are shared with the consumers and the merchants in the form of one or more reports through a notification module/report module.

According to an embodiment herein, the method further comprises requesting the consumer to provide one or more personal details of the consumer he/she is referring for the merchant to contact this newly created lead.

According to an embodiment herein, the method further comprises sending a legal agreement to the merchant for e-signing before completing the registration process.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a comprehensive business and marketing platform/system, according to an embodiment herein.

FIG. 2 illustrates a flowchart explaining a method on-boarding the user with the platform/system, according to an embodiment herein.

FIG. 3 illustrates a flowchart explaining a method for on-boarding the merchant with the platform/system, according to an embodiment herein.

FIG. 4 illustrates a flowchart explaining a method for crediting a cash back in user account in the platform/system, according to an embodiment herein.

FIG. 5 illustrates a flowchart explaining a method for referring a lead, in the platform/system, according to an embodiment herein.

FIG. 6 illustrates a flowchart explaining an example method for referring a real estate lead in the platform/system, according to an embodiment herein.

FIG. 7 illustrates a flowchart explaining an example method for referring attorney/legal lead through the platform/system, according to an embodiment herein.

FIG. 8 illustrates a flowchart explaining a method for converting a lead to sale in the platform/system, according to an embodiment herein.

FIG. 9 illustrates a flowchart explaining a method for rating consumer and merchant at the end of transaction in the platform/system, according to an embodiment herein.

FIG. 10 illustrates a flowchart explaining a method for providing a global business platform that enables consumers to refer friends, family members and other consumers including themselves to businesses, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein disclose a system for providing a comprehensive business platform. The platform comprises a server communicatively coupled with one or more computing devices of the consumers and the merchants involved in a business activity, and wherein the one or more computing devices comprise a smartphone, a computer, a tablet and a personal digital assistant (PDA). The server comprises an on-boarding module configured for registering a plurality of consumers and merchants involved/engaged in a business activity with the system. The plurality of consumers and merchants register with the system through the respective computing devices by providing one or more personal details. The server also comprises a marketing module configured for enabling the merchants registered with the platform to advertise and sell their brand names, products and services to the consumers. The server further comprises a transaction processing module configured for processing the transactions related to the products and services purchased by the consumers using the platform. The transaction details of all the transactions performed through the platform are stored in the database. The server still further comprises a referral tracking module configured for keeping a track of the consumers who refer other consumers to the platform. The server still further comprises a reward allocation module configured for rewarding a referral fees to the consumers for referring themselves other consumers/leads to the platform.

According to an embodiment herein, the server further comprises a verification module configured for verifying the personal details of each consumer and merchant before on-boarding/registering to the marketing and business platform.

According to an embodiment herein, the server further comprises an analysis module configured for analyzing the data stored in the database to determine a consumer behavior and a merchant behavior, and wherein the analysis results are shared with the consumers and the merchants in the form of one or more reports.

According to an embodiment herein, the server further comprises a rating module configured for enabling the consumers and the merchants to rate each other at the end of each transaction. The consumers are prompted to rate/evaluate the merchant based on the services provided and the merchants are prompted/enabled to rate the consumer based on the quality of the referral.

According to an embodiment herein, the consumer referring other consumers to the platform are termed as marketing associates. The reward allocation module is further configured for allocating a reward/referral fee to the consumers when the lead results in a sale. The reward comprises loyalty points, discount coupons, cash back offer, gift voucher/card and product and service rebate.

According to an embodiment herein, the server further comprises a ledger module configured for recording all the leads and sales resulting from that lead, and wherein merchants are enabled to download consolidated transactional information from the ledger module.

According to an embodiment herein, the platform is further configured for providing a downloadable mobile application and web application respectively for the consumers and the merchants to access the platform. The consumers and merchants are registered with the platform through the mobile application and web application after downloading and installing the application and after providing one or more personal details. The consumer is enabled to create a profile during registration with the system. The merchant need to pay a licensing fee during registration.

According to an embodiment herein, the on-boarding/log-in module is further configured for sending a legal agreement to the merchant for e-signing before completing the registration process.

According to an embodiment herein, the platform enables the consumers to make payments using the credit cards, debit cards, prepaid cards, cash on delivery, internet banking and link payments.

According to an embodiment herein, the one or more personal details provided by the merchant during registration with the system comprise a business name, description, address location, phone number, email ID, debit/credit card details, Venmo/Paypal account details, hours of operation, business logo and social media links.

According to an embodiment herein, the one or more personal details provided by the consumer during registration with the system comprise phone number, email

ID and debit/credit card details.

According to an embodiment herein, the consumer needs to provide one or more personal details of the consumer he/she is referring for the merchant to contact this newly created lead.

According to an embodiment herein, a method is provided for creating a global business and marketing platform that enables consumers to refer friends, family members and other consumers including themselves to businesses. The method comprises providing a downloadable mobile and web application for the plurality of consumers and merchants respectively to install on the computing devices to onboard the platform. The plurality of consumers and merchants are registered with the platform using one or more personal details provided by individual consumer and merchant through the respective user devices/computing devices. The merchants are enabled to advertise and sell their brand names, products and services to the consumers through the platform using an interactive/transaction module/application. The consumers are enabled to buy the one or more products or services marketed by the merchants through the platform using the interactive/transaction module/application. The transactions related to the products and services purchased by the consumers are processed and analyzed through an analysis module using the platform. The transaction details of all the transactions performed through the platform are stored in a database. The plurality of consumers and the plurality of merchants are prompted to evaluate/rank/rate each other through a ranking module at the end of each transaction. The consumers are advised/enabled to refer themselves or other consumers to the platform through a referral module. The consumers are awarded/rewarded with a referral fees/incentives/vouchers/gift coupons for referring consumer/lead to the platform through an awarding/rewarding module when the lead results into a sale.

According to an embodiment herein, the method further comprises verifying personal details of each consumer and merchant before on-boarding to the platform through a verification module.

According to an embodiment herein, the method further comprises recording all leads and sales resulting from that lead using a ledger module. The merchants are enabled to download transactional information from the ledger module.

According to an embodiment herein, the method further comprises enabling the consumers to make payments using credit cards, debit cards, prepaid cards, cash on delivery, interne banking and link payments.

According to an embodiment herein, the method further comprises keeping a track of the consumers who refer other consumers to the platform using a referral tracking module.

According to an embodiment herein, the method further comprises analyzing the data stored in the database to determine a consumer behavior and a merchant behavior.

The analysis results are shared with the consumers and the merchants in the form of one or more reports through a notification module/report module.

According to an embodiment herein, the method further comprises requesting the consumer to provide one or more personal details of the consumer he/she is referring for the merchant to contact this newly created lead.

According to an embodiment herein, the method further comprises sending a legal agreement to the merchant for e-signing before completing the registration process.

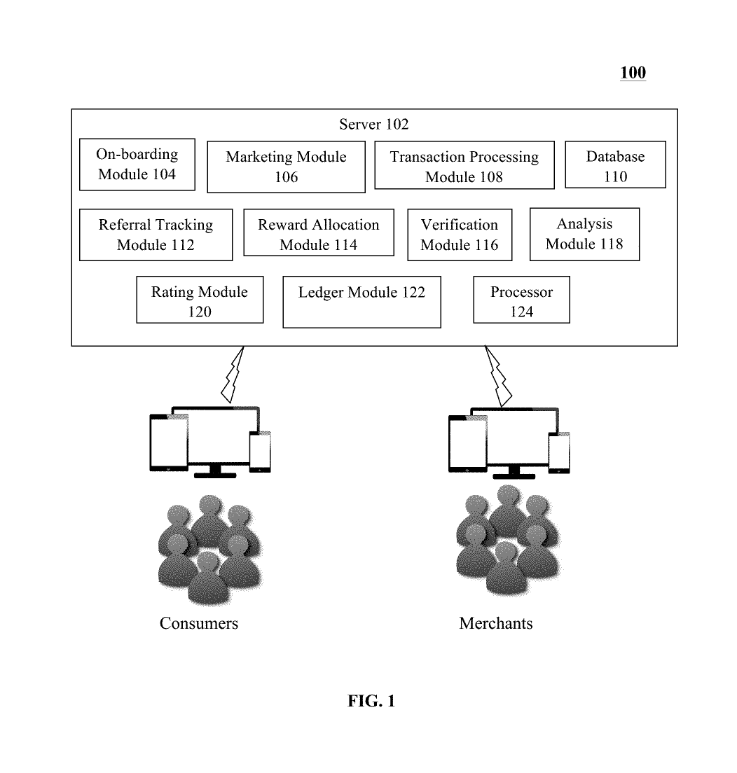

FIG. 1 illustrates a block diagram of a comprehensive business platform, according to an embodiment herein. With respect to FIG. 1, the system comprises a server 102 communicatively coupled with one or more computing devices of the consumers and merchants. The one or more computing devices comprise a smartphone, a computer, a tablet, a personal digital assistant (PDA) and the like. The server 102 comprises an on-boarding module 104 configured for registering a plurality of consumers and merchants with the system. The plurality of consumers and merchants register with the system through computing devices by providing one or more personal details. The server 102 also comprises a marketing module 106 configured for enabling the merchants registered with the platform to advertise and sell their brand names, products and services to the consumers. The server 102 further comprises a transaction processing module 108 configured for processing the transactions related to the products and services purchased by the consumers using the platform. The transaction details for all the transactions performed through the platform are stored in a database 110. The server still further comprises a referral tracking module 112 configured for keeping a track of the consumers who refer other consumers to the platform. The server 102 still further comprises a reward allocation module 114 configured for rewarding a referral fees to the consumers for referring themselves or other consumers/leads to the platform. The consumer referring other consumers to the platform is termed as a marketing associate. The reward allocation module is further configured for allocating a reward to the consumers when the lead results in a sale. The reward comprises loyalty points, discount coupons, cash back, gift voucher/card, product and service rebate and the like.

According to an embodiment herein, the server 102 further comprises a verification module 116 configured for verifying personal details of each consumer and merchant before on-boarding to the platform. The server 102 further comprises an analysis module 118 configured for analyzing the data stored in the database to determine consumer and merchant behavior. The analysis results are shared with the consumers and merchants in the form of one or more reports. The server 102 further comprises a rating module 120 configured for enabling the consumers and merchants to rate each other at the end of each transaction. The consumer rates the merchant based on the services provided and merchant rates the consumer based on the quality of the referral.

According to an embodiment herein, the server 102 further comprises a ledger module 122 configured for recording all leads and sales resulting from that lead. The merchants do not have the ability to upload and consolidate transactional information on the ledger module 122. However, the merchants are enabled to download transactional information from the ledger module 122.

According to an embodiment herein, the platform is further configured for providing a downloadable mobile application and web application for the consumers and merchants respectively to access the platform. The consumers and merchants are registered with the platform via the mobile application and web application after downloading and providing one or more personal details. The one or more personal details provided by the merchant during registration with the system comprise business name, description, address location, phone number, email ID, debit/credit card details, Venmo/Paypal account details, hours of operation, business logo and social media links. The merchant need to pay a licensing fee during registration. The consumer is enabled to create a profile during registration with the system. The one or more personal details provided by the consumer during registration with the system comprise phone number, email ID and debit/credit card details. The consumer also needs to provide one or more personal details of the consumer he/she is referring for the merchant to contact the newly created lead. The platform enables the consumers to make payments using credit cards, debit cards, cash on delivery and link payments.

FIG. 2 illustrates a flowchart explaining a method for user on-boarding with the system, according to an embodiment herein. With respect to FIG. 2, the consumer downloads the mobile application on his/her computing device (202). The system then verifies the phone number of the consumer and on successful verification a user profile is set up (204). The consumer is also requested to link payment either by providing credit/debit card details or Paypal account details (206). For all categories except for hospitality and some major retail, consumers usually link payment or debit card. The various deals available on the platform are then displayed to the consumer (208). Consumer is allowed to refer other consumers via a link and receive rewards and incentives (210). The consumer is also facilitated to go to the user dashboard to view the summary of activity (212).

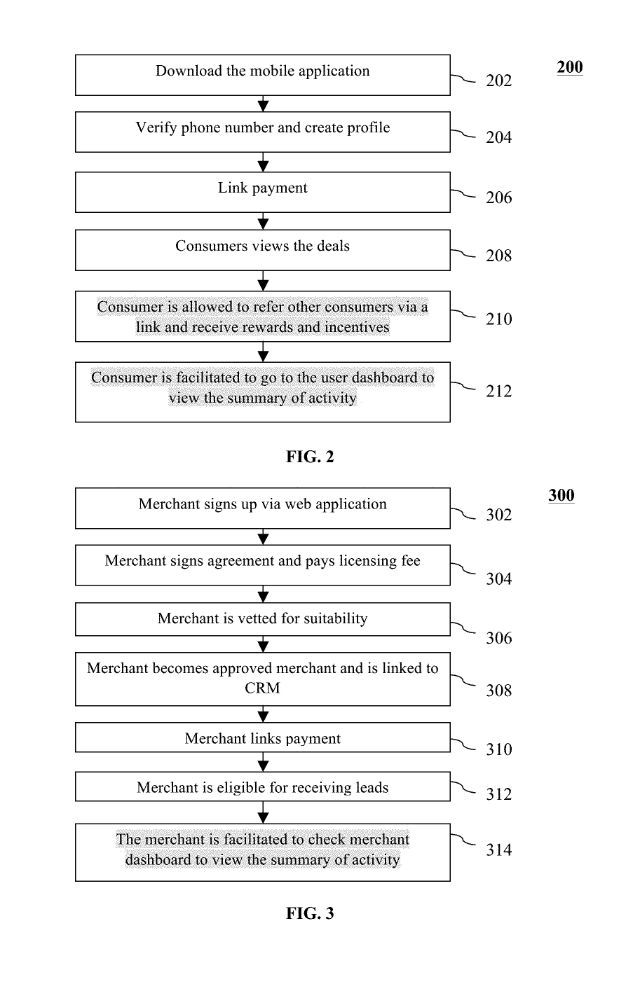

FIG. 3 illustrates a flowchart explaining a method for merchant on-boarding, according to an embodiment herein. With respect to FIG. 3, the merchant signs up with the system via web application (302). The merchant is requested to provide one or more personal details while signing up with the system. The one or more personal details comprise business name, description, address location, phone number, email ID, debit/credit card details, Venmo/Paypal account details, hours of operation, business logo and social media links. The merchant then signs an agreement (e.g. via DocuSign) and pays a pre-defined licensing fees (304). A payment link is sent to the merchant for payment of the licensing fees, the payment of which allows him to show up as a preferred merchant. Businesses that do not become preferred still show up on the app but do not receive any leads. The system then carefully vets the merchant suitability for the platform (306). The concerned authority governing the application operations then vets the merchant using a predetermined protocol. When vetting results in a successful outcome (again defined by vetting protocol), merchant on-boarding is approved. Once the system approves the merchant on-boarding, the CRM linking is done (308). The merchant is further requested to link payment details (e.g. credit card, debit card details, Venmo, Paypal etc.) with the system (310). The merchant is then considered to be eligible for receiving leads (312). The merchant is further facilitated to check the merchant dashboard to view the summary of activity (314).

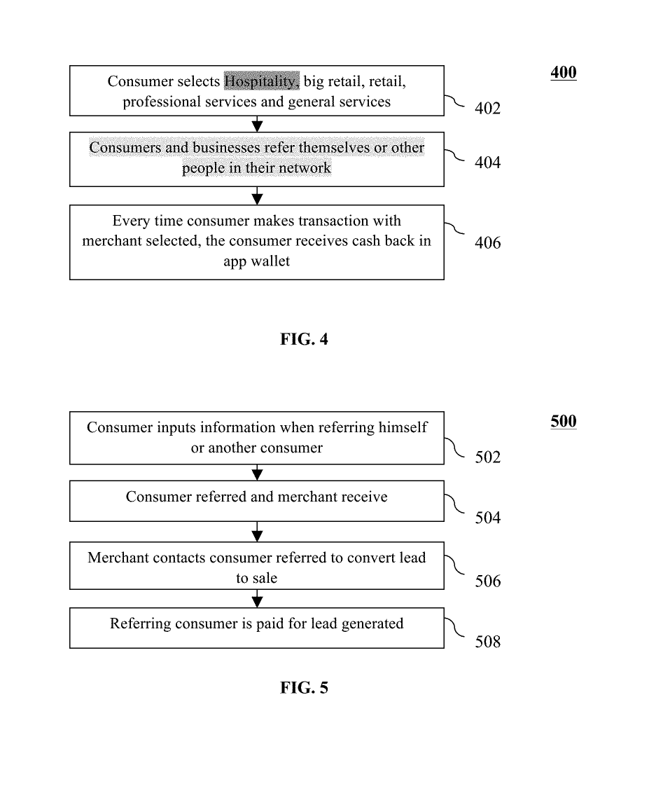

FIG. 4 illustrates a flowchart explaining a method for cash back credited in user account, according to an embodiment herein. With respect to FIG. 4, consumer selects hospitality, big retail, retail, professional services and general services put credit card on file (402). Consumers and businesses refer themselves or other people in their network (404). A third party takes a predetermined time (e.g. 24 hours) to validate the card on file. Every time consumer makes transaction with merchant(s) selected, they receive cash back in app wallet (406).

According to an embodiment herein, the cash back portion of the user interface (UI) applies to merchants in the hospitality and major retail domains. There are no referrals and no payments made for leads converting to sales. Merchants do not pay for leads. Application needs participation of hospitality and major retail due to a consumer's propensity and frequency to buy within these domains.

According to an embodiment herein, consumers make direct payments using the mobile application when making online purchases through the application. In the cash back user interface, consumers put a credit card on file which gets charged by a third party when consumer selects hospitality or major retail business. All payments from leads or cash back are deposited in the consumer's application wallet. Consumers are enabled to transfer the money out of their application wallet via bank account number or Paypal.

FIG. 5 illustrates a flowchart explaining a method for referring a lead, according to an embodiment herein. With respect to FIG. 5, consumer inputs information when referring himself or another consumer (502). The merchant receives details about the consumer referred (504). The merchant then contacts consumer referred to convert lead into sale (506). The referring consumer is paid for lead generated (508). In this lead referral process, consumer refers himself or another consumer to a merchant. Referring consumer inputs information of the consumer he/she is referring for the merchant to contact this newly created lead. The information inputted comprises name, email, phone number and best time to reach.

FIG. 6 illustrates a flowchart explaining an example method for referring a real estate lead, according to an embodiment herein. With respect to FIG. 6, consumer searches for real estate purchase or real estate loan (602). Real estate companies are notified about this (604). The agents or companies bid on leads (606). Lead is awarded to three agents or real estate companies (608). The agents or companies then pursue the lead independent of the application (610).

According to one embodiment of the present invention, in the real estate referral system, consumer refers himself or another consumer. Referring consumer is paid for the lead. Higher amount is paid if referring consumer has a high rating. Lead is offered up and bid upon by participating real estate agents and real estate companies. Lead is then awarded. Winning agent/company then contacts lead to pursue opportunity independent of the application. Referring consumer does not get paid if lead converts to sale.

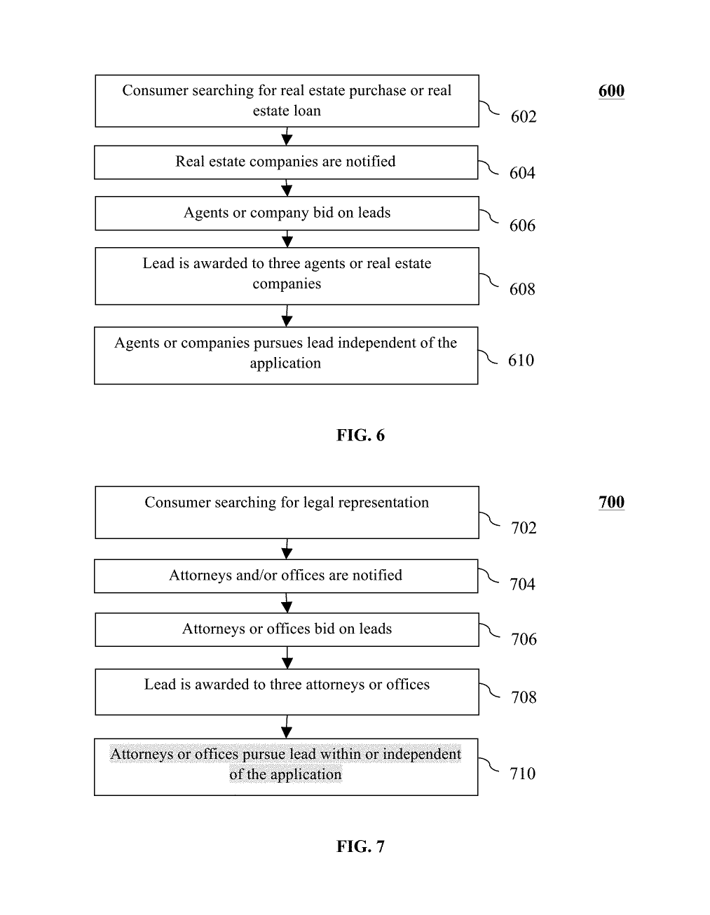

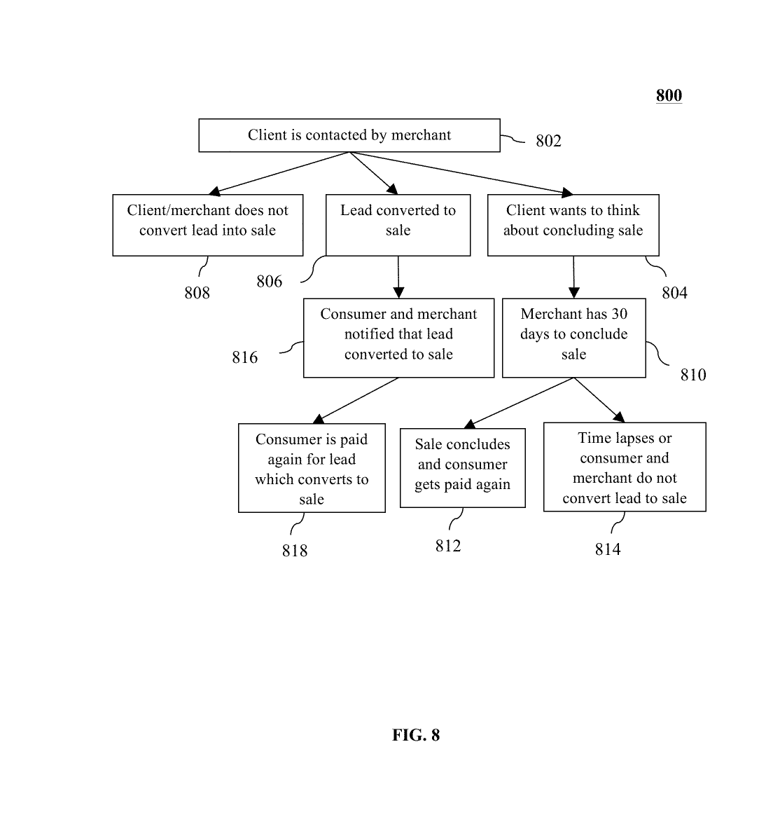

FIG. 7 illustrates a flowchart explaining an example method for referring attorney/legal lead, according to an embodiment herein. With respect to FIG. 7, consumer searches for legal representation (702). Attorneys and offices are notified about this (704). The attorneys and offices bid on the leads (706). The lead is awarded to three attorneys or offices (708). The attorneys or offices then pursue the lead within or independent of the application (710).

FIG. 8 illustrates a flowchart explaining a method for lead converting to sale, according to an embodiment herein. With respect to FIG. 8, the client is contacted by the merchant (802). There are three possible outcomes of this meeting. The first being, client wants to think about concluding sale (804). The second being, lead is converted to sale (806) and the third being, client/merchant does not convert lead to sale (808). In the first case, merchant is given some time (e.g. 30 days) to conclude the sale (810). The outcome of this is either sale concludes and consumer gets paid again (812) or time lapses or consumer and merchant do not convert lead to sale (814). The outcome of second case is that consumer and merchant are notified that lead is converted to sale (816). After notification, consumer is paid again for lead which converts to sale (818).

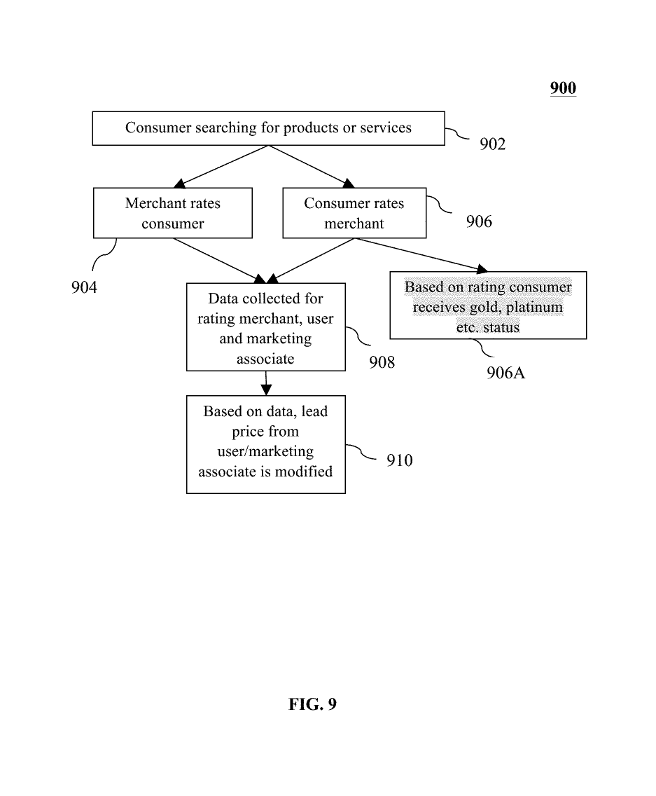

FIG. 9 illustrates a flowchart explaining a method for consumer and merchant providing rating for each other at the end of transaction, according to an embodiment herein. With respect to FIG. 9, consumer searches for products or services (902). When the consumer finds appropriate product and completes the transaction for buying it, the merchant rates the consumer (904) and the consumer rates the merchant (906). Based on the rating received, the consumer achieves gold, platinum etc., status (906A). The data related to these ratings and the marketing associate is collected (908). Based on the collected data, lead price from user/marketing associate is modified (910).

According to an embodiment herein, a consumer with a high rating means that quality of future leads coming from that consumer is of a high caliber, with a greater likelihood of that lead resulting in a sale. Merchants want to receive leads from highly rated consumers and are comfortable paying more for that lead given the consumer history. And the consumer with a higher rating is paid more for a lead.

On the contrary, merchant receiving lead from a consumer with a lower rating has less confidence in that lead based on historic data and thus pays less for such a lead. When the lead results in a sale, consumer receives the same payment irrespective of rating.

According to an embodiment herein, consumers want to refer leads to those merchants with a higher rating because there is a greater likelihood of that lead resulting in a sale. Consumers make money from the lead being converted into a sale and receive a high rating from the merchant making more valuable future leads from that consumer. However, consumer with a low rating is paid less for a lead. When consumer rating drops below a specified threshold, consumer is no longer paid for referring a lead. Consumer still makes money when the lead refers in a sale.

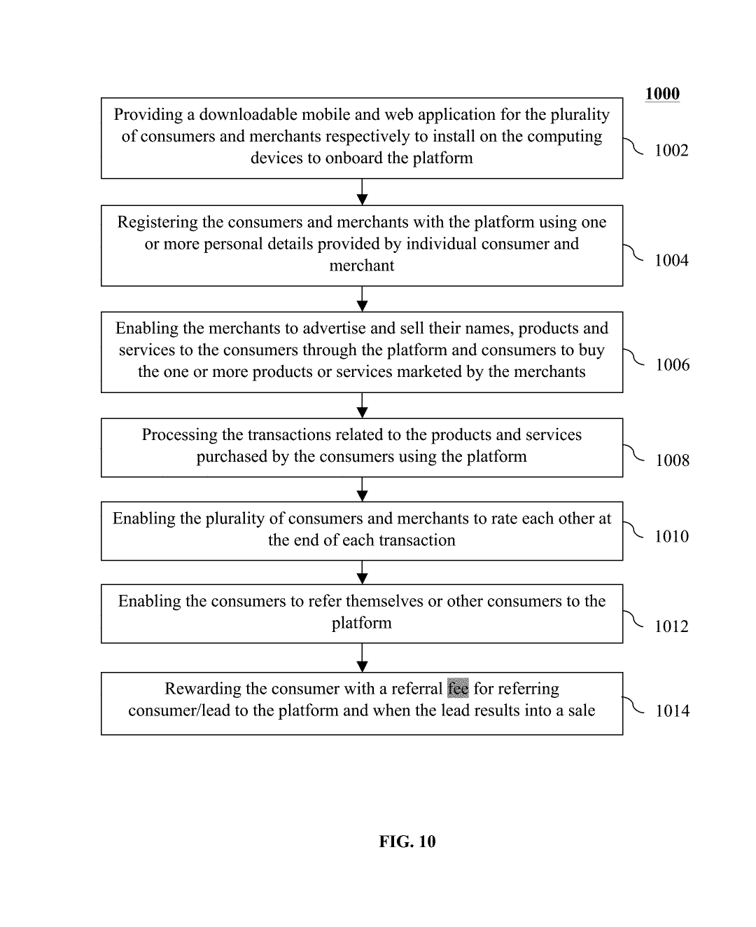

FIG. 10 illustrates a flowchart explaining a method for providing a global business platform that enables consumers to refer friends, family members and other consumers including themselves to businesses, according to an embodiment herein. With respect to FIG. 10, the method comprises providing a downloadable mobile and web application for the plurality of consumers and merchants respectively to install on the computing devices to onboard the platform (1002). The method also comprises registering the consumers and merchants with the platform using one or more personal details provided by individual consumer and merchant (1004). The method further comprises enabling the merchants to advertise and sell their brand names, products and services to the consumers through the platform and consumers to buy the one or more products or services marketed by the merchants (1006). The method still further comprises processing the transactions related to the products and services purchased by the consumers using the platform (1008). The method still further comprises enabling the plurality of consumers and merchants to rate each other at the end of each transaction (1010). The method still further comprises enabling the consumers to refer themselves or other consumers to the platform (1012) and rewarding the consumer with a referral fee for referring consumer/lead to the platform and when the lead results into a sale (1014).

Therefore, the embodiments herein provide a system and method for providing a global business platform that enables consumers to refer friends, family members and other consumers including themselves to businesses. In this system and method consumers are financially awarded for word-of-mouth lead and are paid when lead results in a sale. Merchants are given access to word-of-mouth leads from consumers they may not know or have done business with and this helps them in expanding the consumer base. Merchant experience an higher close ratio on the word-of-mouth leads rather than risky and uncertain chance marketing schemes such as Google, TV, radio, print, etc.

Further, the mobile/web application provided by the system contains more variety of business categories than any other applications presently available. Consumers are also allowed to refer themselves and make/save money at the same time. Merchants get to rate consumer's lead. Consumers and merchants have a platform to deal with each other seamlessly.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A comprehensive business and marketing system, the system comprising:
a server communicatively coupled with one or more computing devices of a plurality of consumers and a plurality of merchants, and wherein the one or more computing devices comprise a smartphone, a computer, a tablet and a personal digital assistant (PDA);
an on-boarding module provided in the server and run on a hardware processor, and wherein the on-boarding module is configured for registering the plurality of consumers and the plurality of merchants with the system, and wherein the plurality of consumers and the plurality of merchants are enabled/prompted/notified to register with the system through the respective user computing devices by providing one or more personal details;
a marketing module provided in the server and run on a hardware processor, and wherein the marketing module is configured for enabling the plurality of merchants registered with the platform to advertise ones brand names and sell products and services to the plurality of consumers;
a transaction processing module provided in the server and run on a hardware processor, and wherein the transaction processing module is configured for processing the transactions related to the products and services purchased by the plurality of consumers, and wherein the transaction details of all the transactions performed are stored in the database;
a referral tracking module provided in the server and run on a hardware processor, and wherein the referral tracking module is configured for keeping a track of the plurality of consumers who refer other consumers to the system; and
a reward allocation module provided in the server and run on a hardware processor, and wherein the reward allocation module is configured for rewarding a referral fees to the consumers for referring themselves and other consumers/leads to the platform.

2. The system according to claim 1, wherein the server further comprises a verification module, and wherein the verification module is configured for verifying personal details of each consumer and merchant before on-boarding to the platform.

3. The system according to claim 1, wherein the server further comprises an analysis module, and wherein the analysis module is configured for analyzing the data stored in the database to determine a consumer behavior and a merchant behavior, and wherein the analysis module is configured to share analysis results with the consumer and the merchant in the form of one or more reports.

4. The system according to claim 1, wherein the server further comprises an evaluation/ranking/rating module configured for enabling the plurality of consumers and the plurality of merchants to rate/evaluate/rank each other at the end of each transaction, and wherein the consumer is enabled to evaluate/rank/rate the merchant based on services provided and wherein the merchant is enabled to evaluate/rank/rate the consumer based on purchases and successful referrals made.

5. The system according to claim 1, wherein the consumer referring other consumers to the platform are termed as marketing associates, and wherein the reward allocation module is further configured for allocating a reward/referral fee to the consumers when the lead results in a sale, and wherein the reward comprises loyalty points, discount coupons, cash back, gift voucher/card and product and service rebate.

6. The platform according to claim 1, wherein the server further comprises a ledger module configured for recording all leads and sales resulting from a lead provided by each consumer, and wherein the plurality of merchants are enabled to download consolidated transactional information from the ledger module.

7. The system according to claim 1, wherein the server is further configured for providing a downloadable mobile application and web application for the plurality of consumers and the plurality of merchants respectively to access the server, and wherein the plurality of consumers and the plurality of merchants are registered with the server through the mobile application and web application after downloading and providing one or more personal details, and wherein the consumer is enabled to create a profile during registration with the server, and wherein the merchant is advised or prompted to pay a licensing fees during registration process.

8. The system according to claim 1, wherein the on-boarding module is further configured for sending a legal agreement to the merchant for e-signing before completing the registration process.

9. The system according to claim 1, further comprises a payment module which is run on the processor and configured to enable the plurality of consumers to make payments through credit cards, debit cards, prepaid cards, cash on delivery and link payments.

10. The system according to claim 1, wherein the one or more personal details provided by the merchant during registration with the system comprise business name, description, address location, phone number, email ID, debit/credit card details, Venmo/Paypal account details, hours of operation, business logo and social media links.

11. The system according to claim 1, wherein the one or more personal details provided by the consumer during registration with the system comprise phone number, email ID and debit/credit card details.

12. The system according to claim 1, wherein the referral module is configured to prompt/advise/notify the consumer to provide one or more personal details of the consumer to be referred for the merchant to contact this newly created lead.

13. A computer implemented method comprising instructions stored on a non-transitory computer readable storage medium and run a computing device provided with a hardware processor and memory for providing a global business platform that enables consumers to refer friends, family members and other consumers including themselves to businesses through one or more algorithms, wherein the method comprises steps of:
providing a downloadable mobile and web application for the plurality of consumers and merchants respectively to on a user computing devices from a server for installation to onboard/register with a system;
registering the plurality of consumers and the plurality of merchants with the system using one or more personal details provided by each consumer and each merchant through a registration module;
enabling the plurality of merchants to advertise and sell their brand names, products and services to the consumers through a marketing and sales module and to enable the plurality of consumers to buy one or more products or services marketed by the plurality of merchants through the marketing and sales module;
processing transactions related to the products and services purchased by the plurality of consumers through a transaction module, and wherein the transaction details of all the transactions performed through the platform are stored in a database;
enabling the plurality of consumers and the plurality of merchants to evaluate/rank/rate each other at an end of each transaction or after completion of each transaction;
enabling the plurality of consumers to refer themselves or other consumers through a referral module; and
rewarding the consumer with a referral fees for referring consumer/lead through a rewarding/awarding module, when the lead results into a sale.

14. The method according to claim 13, further comprises verifying personal details of each consumer and each merchant with a verification module before on-boarding/registering to the server/system.

15. The method according to claim 13, further comprises recording all leads and sales resulting from a given lead using a ledger module, and wherein the plurality of merchants are enabled to download transactional information from the ledger module.

16. The method according to claim 13, further comprises enabling the plurality of consumers to make payments using credit cards, debit cards, cash on delivery and link payments through a payment module.

17. The method according to claim 13, further comprises keeping a track of the consumers who refer other consumers to the platform using a referral tracking module.

18. The method according to claim 13, further comprises analyzing the data stored in the database to determine a consumer behavior and a merchant behavior with an analysis module, and wherein the analysis module is configured to notify and share results of analysis with the plurality of consumers and the plurality of merchants in a form of one or more reports.

19. The method according to claim 13, further comprises requesting the consumer to provide one or more personal details of the consumer he/she is referring for the merchant to contact this newly created lead by the referral tracking module.

20. The method according to claim 13, further comprises sending a legal agreement to the merchant for e-signing before completing the registration process through a legal module.
